(19) United States
(12) Patent Application Publication
(10) Pub. No.: US 2016/0213011 A1
(43) Pub. Date: Jul. 28, 2016

(54) SANITARY CUTTING APPARATUS, SYSTEM AND METHOD FOR PRE-COOKED MEAT PRODUCTS

(71) Applicant: David Howard, Bristow, OK (US)

(72) Inventor: David Howard, Bristow, OK (US)

(21) Appl. No.: 14/604,181

(22) Filed: Jan. 23, 2015

(51) Int. Cl. A22C 17/00; A23B 4/005

(52) U.S. Cl. CPC A22C 17/0006; A23B 4/005; A23V 2002/00

(57) ABSTRACT

A vertical cutting apparatus for cooked meat products which can be installed on the outlet of a spiral oven or other heating apparatus for directly receiving and cutting the cooked product in sterile condition while still hot in order to prevent cross-contamination of either the (a) sliced, cubed, diced, or shred cut product or (b) the cutting apparatus. The hot product can also be delivered directly from the vertical cutting apparatus into its final product packaging and immediately vacuum seal for further product safety.

### FIELD OF THE INVENTION

The present invention relates to apparatuses, systems and methods for slicing, dicing, cubing, shred cutting or otherwise cutting cooked chicken, pork, turkey, beef or other cooked meat products. In another aspect, the present invention relates to apparatuses, systems, and methods for cooking such meat products and then cutting the cooked meat products while still hot.

### BACKGROUND OF THE INVENTION

With the growth of demand for pre-cooked ready-to-eat meat products, there exists a continuing need for improved processing apparatuses, systems and methods which will eliminate food safety risks. As early as the mid-1990's, the American Meat Institute (A.M.I.) lobbied the U.S.D.A. to introduce protocols for Hazard Analysis Critical Control Points (HACCP) in food processing systems. This effort is specific to managing risk.

By identifying and monitoring critical points in the processing system, objectives and goals for controlling pathogen or bacterial growth can be identified. This, in turn, stimulates the development of solutions to reduce or eliminate contamination risks and improve food safety.

In recent years, there has been enormous growth in the demand for pre-cooked meats which are sliced, diced, cubed, shred cut, or otherwise cut in some form. In particular, an increasing demand exists for pre-cooked products such as fajita strips or assembled meals or sandwiches which use strips of meat, e.g., chicken, beef, or pork—predominately chicken.

Currently, a typical process for preparing and cutting these types of pre-cooked meat products will comprise the steps of: (1) injecting the raw chicken or other meat product with a solution comprising water, salt, phosphate, soy protein, sodium lactate and/or flavorings; (2) vacuum tumbling the product in a marinade; (3) pumping the product onto the surface of a belt grill; (4) transferring the product, as individual pieces or in a bonded sheet form, onto a bar-marker to brand it; (5) cutting the product, if in sheet form, into lengths of nominally 15″ to travel through a spiral cooker; (6) transferring the product from the cooker into and through a spiral or linear pre-chiller; (7) transfer the product from the pre-chiller to a conveyor feeding a cutting apparatus for slicing, cubing, or dicing the cooked product; (8) delivering the product horizontally through the cutting apparatus; (9) transferring the product on a vibrating conveyor from the cutting apparatus into a spiral freezer; and (10) conveying the product from the exit of the spiral freezer to a packaging machine.

Once the product is fully cooked, i.e., at the exit of the oven, it is pathogen-free. However, after exiting the oven, the cooked product travels along a critical control path during which it is exposed to many contamination risks prior to and during the eventual packaging operation. In addition, any bacteria or pathogens which collect on the product will cross-contaminate further surfaces in the processing line as the contaminated product is conveyed through the system.

One of the most notorious places for cross-contamination is the cutting apparatus. Prior to the cutting apparatus, there were many areas or surfaces that come into contact with the product. Once these areas/surfaces become contaminated with pathogens, the meat product will collect and transmit the pathogens onto the slicing blades and other surfaces of the cutting apparatus, thus resulting in the formation of biological films on these surfaces. Consequently, the product, having been cooked and chilled, is put at significant risk of contamination as it is being cut into strips, cubes or slices.

Typical apparatuses used heretofore for slicing, cubing, dicing, etc. require a hold-down belt to help convey the product through the cutting head. These belts are difficult to keep clean. Also, because the belt applies pressure to the product, the product must be pre-chilled prior to cutting. If the product were to be sliced, cubed or diced while still hot, the pressure applied by the hold-down belt would squeeze a significant amount of moisture from the hot product. Furthermore, upon releasing the hot product from the hold-down belt such that this squeezing pressure is suddenly removed, the hot product would expand in a manner similar to a sponge and thereby absorb liquid released from the products traveling ahead of it which had previously passed through the cutting apparatus. Thus, in effect, creating a microbial bath.

For these reasons, and due to the loss of yield or cooked weight which would be caused by the squeezing pressure applied to the product by the hold-down belt, hot slicing has been avoided.

### SUMMARY OF THE INVENTION

The present invention satisfies the needs and alleviates the problems discussed above. The present invention provides a vertical cutting apparatus, as well as inventive methods and systems which utilize the inventive vertical cutting apparatus, wherein chicken, turkey, beef, pork, or other meat products can be sliced, cubed, diced, shred cut, or otherwise cut, without pressing or squeezing, after cooking while the cooked product is still hot. The product is preferably delivered directly to the inventive vertical cutting apparatus immediately upon exiting the cooking oven. In addition, the cutting apparatus and the cutting blades and cutting head thereof are preferably heated and maintained at a sufficient temperature to prevent pathogens from surviving and growing on the food contacting surfaces and areas within the inventive apparatus.

In one aspect, there is provided an apparatus for vertically cutting a food product comprising: a housing having an upper product inlet opening; a cutting head driveably installed in the housing for driven rotation of the cutting head in a cutting direction; a roller rotatably installed in the housing adjacent and parallel to the cutting head; an upwardly facing product receiving nip formed between the cutting head and the roller; and a vertical cutting path defined in the apparatus which travels downwardly into the upwardly facing product receiving nip and then continues downwardly between the cutting head and the roller.

In another aspect, there is provided an assembly for cutting a sterile cooked meat product comprising a heating apparatus having a product outlet and a vertical cutting apparatus installed on the heating apparatus beneath the product outlet of the heating apparatus. The vertical cutting apparatus preferably comprises: a housing having an upper product inlet opening; a cutting head driveably installed in the housing for driven rotation of the cutting head in a cutting direction; a roller rotatably installed in the housing adjacent and parallel to the cutting head; an upwardly facing product receiving nip formed between the cutting head and the roller; and a vertical cutting path defined in the vertical cutting apparatus which travels downwardly into the upwardly facing product receiving nip and then continues downwardly between the cutting head and the roller.

In another aspect, there is provided a method of producing a pre-cooked meat product comprising the steps of: (a) delivering a meat product through a heating apparatus to a product outlet of the heating apparatus and (b) cutting the meat product into separate smaller pieces by delivering the meat product vertically downward from the product outlet of the heating apparatus through a vertical cutting apparatus positioned below the product outlet of the heating apparatus.

Further aspects, features, and advantages of the present invention will be apparent to those of ordinary skill in the art upon examining the accompanying drawings and upon reading the following Detailed Description of the Preferred Embodiments.

### BRIEF DESCRIPTION OF THE DRAWINGS

FIG. 1 is a perspective view of an embodiment 2 of a cooking and cutting assembly and system provided by the present invention.

FIG. 2 is an elevational view of the inventive cooking and cutting assembly and system 2.

FIG. 3 is another perspective view of the inventive cooking and cutting assembly and system 2.

FIG. 4 is an elevational side view of an embodiment 30 of the vertical cutting apparatus provided by the present invention.

FIG. 5 is a partially cut-away top view of the inventive vertical cutting apparatus 30.

FIG. 6 is an enlarged view of Detail A identified in FIG. 5.

FIG. 7 is an elevational front interior view of the inventive vertical cutting apparatus 30.

### DETAILED DESCRIPTION OF THE PREFERRED EMBODIMENTS

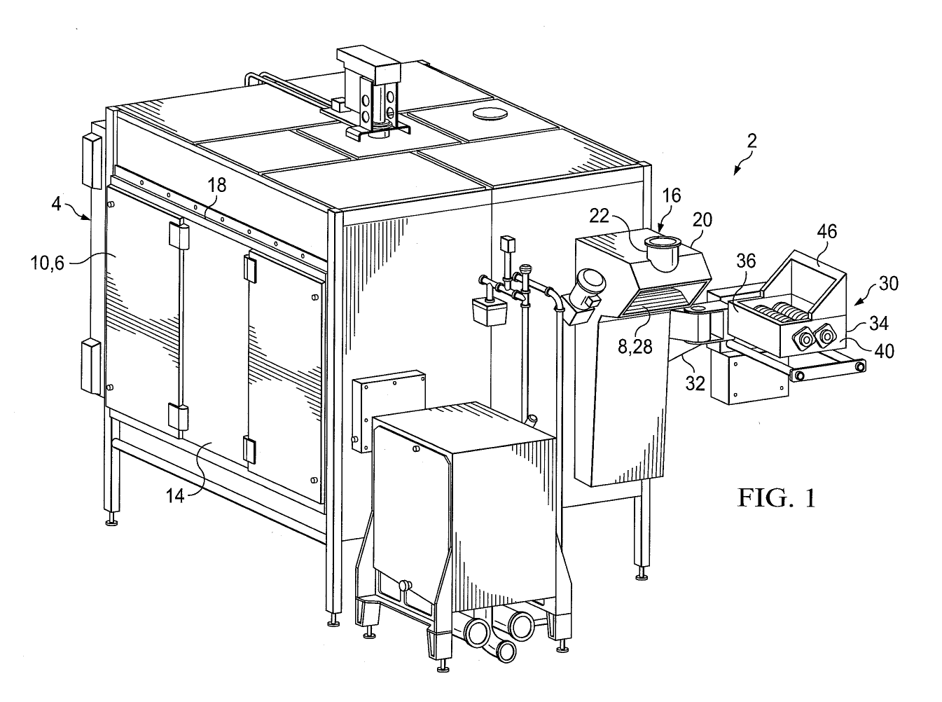

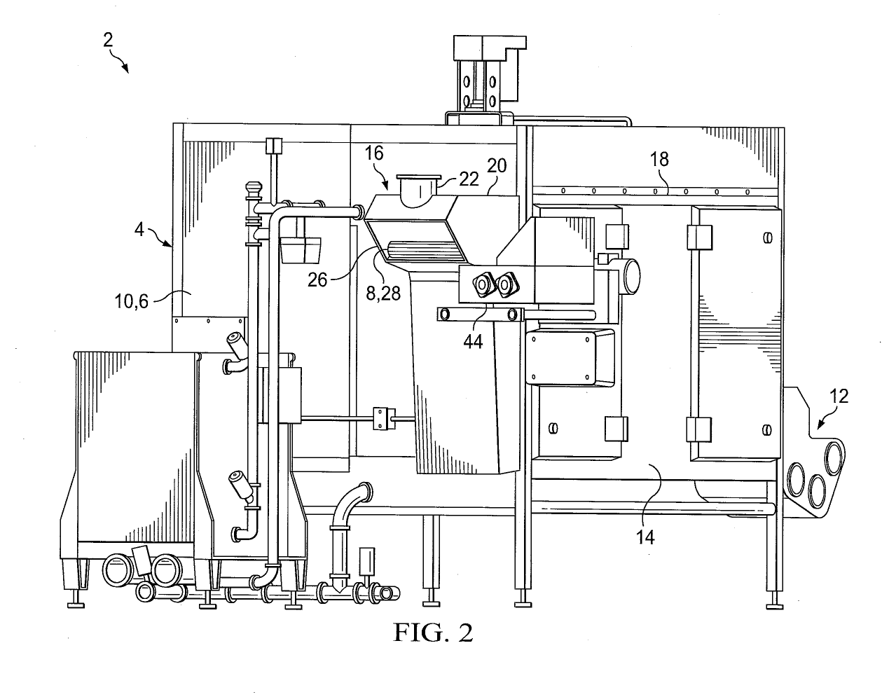

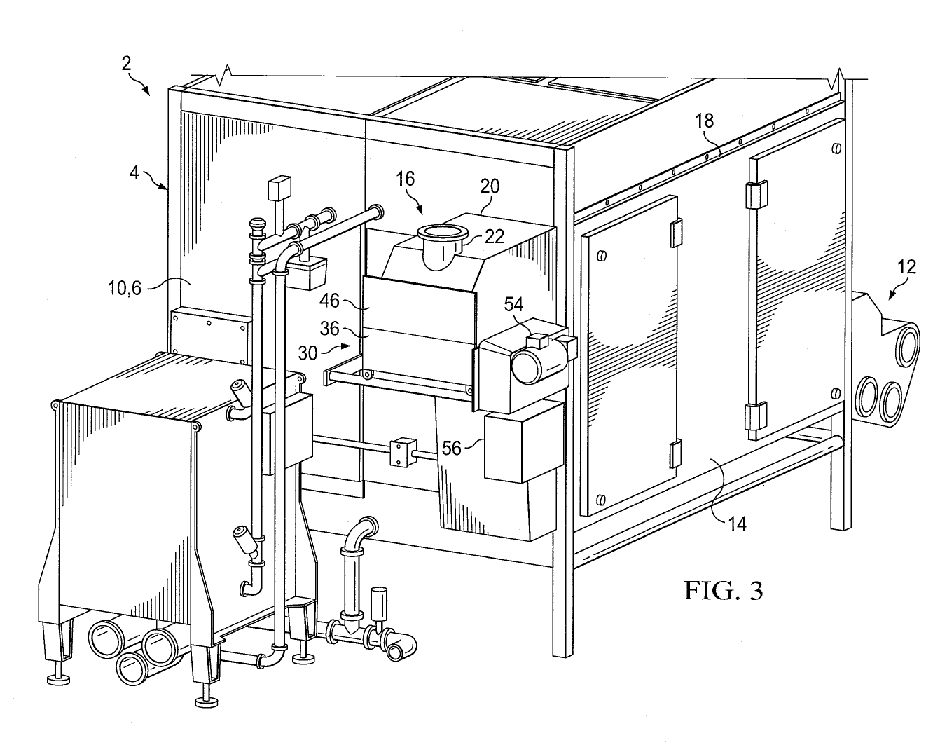

An embodiment 2 of a cooking and cutting assembly and system provided by the present invention is illustrated in FIGS. 1-3. The inventive system 2 comprises a heating apparatus 4 and an embodiment 30 of the inventive vertical cutting apparatus. The heating apparatus used in the inventive assembly 2 is preferably a spiral oven.

The spiral oven 4 comprises; an oven housing 6 having a cooking chamber 10; an oven belt 8 which preferably conveys the chicken, turkey, pork, beef or other meat product through the cooking chamber 10 in an upward spiral path; an oven inlet 12 which is preferably located at or near the bottom end 14 of the cooking chamber 10; an oven outlet 16 which is preferably located at or near the top end 18 of the cooking chamber 10; an exhaust hood 20 installed over the oven outlet 16; and a hood exhaust connection 22 extending upwardly from the top of the exhaust hood 20.

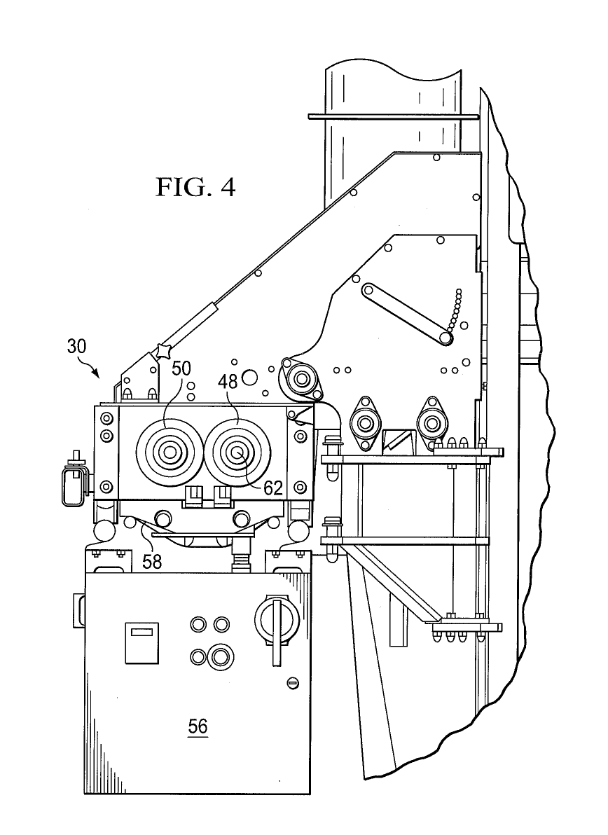

The inventive vertical cutting apparatus 30 is illustrated in FIGS. 1-3 and is further illustrated in FIGS. 4-7. In the inventive assembly 2, the vertical cutting apparatus 30 is moveably installed on the exterior of the oven housing 6, preferably by a pivot arm 32. This allows the vertical cutting apparatus 30 to be moved (preferably pivoted) either (a) into a cutting position beneath the outlet 16 of the oven 4 or (b) away from the oven outlet 16. In the cutting position, the vertical cutting apparatus 30 receives the cooked meat product directly from the outlet end 24 of the oven belt 8 and immediately cuts the product while it is still hot. However, when performing other operations in which the vertical cutting apparatus 30 is not needed, or to facilitate access to the vertical cutting apparatus 30 for cleaning, maintenance or repair, the inventive cutting apparatus 30 can be easily pivoted out of the way.

It will be understood, however, that although the installation of the inventive vertical cutting apparatus 30 on a spiral oven is a particularly desirable embodiment of the inventive assembly 2, the inventive vertical cutting apparatus 30 can alternatively be installed (a) on a separate stand or frame apart from the oven or other heating apparatus 4; (b) on the outlet of any other type of oven (e.g., a linear convection or impingement oven, an infrared oven, a microwave oven, etc.), or (c) on the outlet of still other types of heating apparatuses, e.g., surface pasteurizers which reduce, destroy or remove pathogens which may re-contaminated cooked products which are conveyed or further processed after cooking.

Securing the inventive vertical cutting apparatus 30 on the outlet of an oven, surface pasteurizer, or other heating apparatus is preferred in order to (1) save floor space, (2) eliminate the need for a separate support structure, and/or (3) reduce the number of surfaces upon which pathogens could collect and which would require cleaning. Also, spiral ovens are particularly well suited for direct attachment of the inventive vertical cutting apparatus 30 because of (a) the elevation of the oven outlet 16 which provides room for the cutting apparatus 30 therebeneath without having to raise the oven 4 and (b) the sturdy construction and attachment area available on the exterior of the oven housing 6 for attaching and supporting the vertical cutting apparatus 30.

Referring once again to FIGS. 1-7, the inventive vertical cutting apparatus 30 preferably comprises a blade housing 34 secured on the distal end of the pivot arm 32. The blade housing 34 preferably has: a vertical front 36; a vertical right side 38; a vertical left side 40; a top opening 42 for receiving the cooked product; a bottom opening 44 for discharging the cooked product after slicing, cubing, dicing or otherwise cutting the product into separate smaller pieces; and an upper shield structure 46 which extends upwardly from the front 36, right 38, and left 40 sides of the blade housing 34. The shield structure 46 is preferably shaped and configured to correspond to or mate with the shape of outlet exhaust hood 20 of the oven 4 to thereby (a) substantially close, or at least close to a significant degree, the bottom opening 26 of the hood 20 and (b) place the interior of the blade housing 34 in vapor and/or exhaust communication with the interior of the oven exhaust hood 20. The walls of the blade housing 34 and the shield structure 46 are preferably insulated.

In addition, the inventive vertical cutting apparatus 30 also preferably comprises: (1) a laterally extending cutting head 48 which is driveably installed in the blade housing 34; (2) a laterally extending cutting roller 50 which is rotatably installed in the blade housing 34 and is adjacent and parallel to the cutting head 48; (3) a product receiving nip 52 which is formed between the cutting head 48 and the cutting roller 50 for receiving the cooked meat product; (4) a drive motor 54 for driving (i.e., rotating) the cutting head 48 during the cutting operation; (5) an exterior control panel 56; and (6) a steam supply manifold 58 and one or more interior steam discharge tubes or nozzles 55 for heating and sanitizing the cutting head 48, the cutting roller 50, and other surfaces and areas within the housing 34. The steam discharge tube(s) or nozzle(s) 55 preferably apply steam directly onto the cutting blades.

A vertical cutting path 53 is defined in the cutting apparatus 30 wherein the product travels downwardly into the upwardly facing product receiving nip 52 and then continues downwardly between the cutting head 48 and the cutting roller 50 and out of the bottom opening 44.

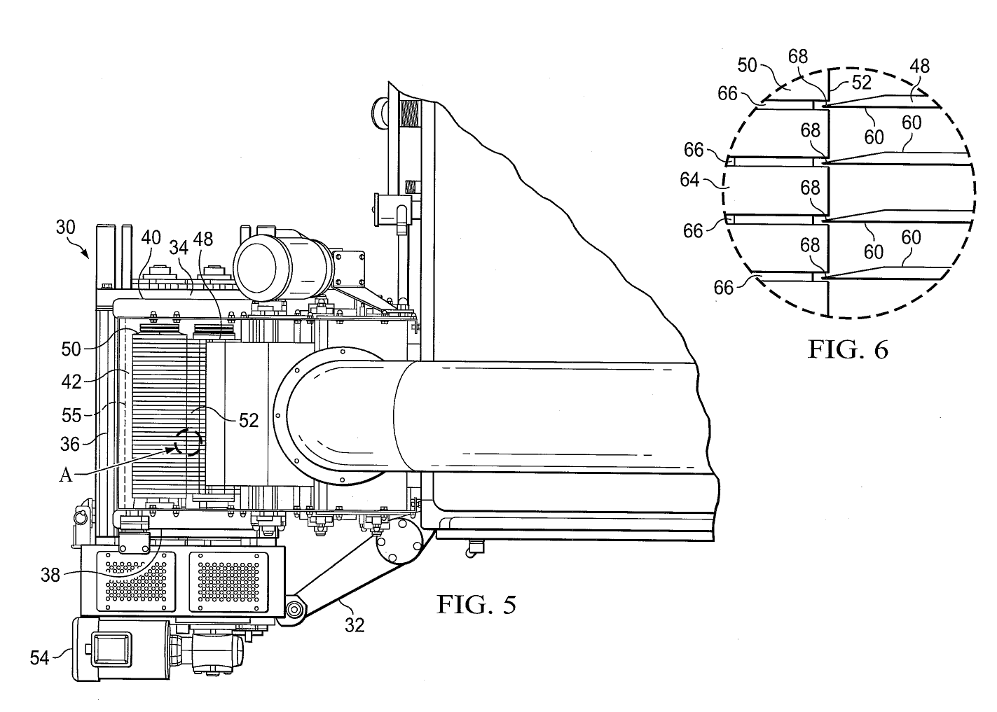

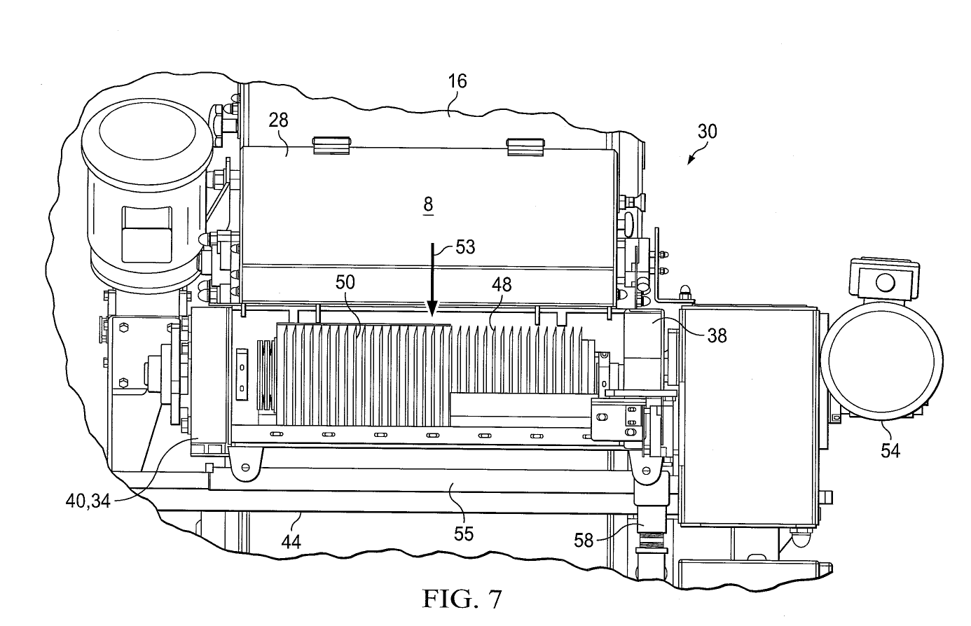

The particular cutting head 48 illustrated in FIGS. 5-7 is a slitter or slicer head comprising a series (i.e., a plurality) of parallel, circular, radial blades 60 secured on an elongate axial rod or cylinder 62. The cutting roller 50 for this cutting head 48 preferably comprises an outer cylindrical surface 64 having a series (i.e., a plurality) of circular radial grooves 66 formed around the roller 50 which correspond to the circular radial blades 60. During operation, the outer radial cutting edges 68 of the circular blades 60 are received in the circular grooves 66 of the cutting roller 50 at the nip 52 (See FIG. 6) to ensure that the blades 60 will cut cleanly through the entire thickness of the meat product to produce separate slices.

As will be understood by those in the art, different blade structures and arrangements, and corresponding groove patterns, will be used on the cutting head 48 and the cutting roller 50 for cubing, dicing, or shred cutting the product or for cutting the product into other types of smaller separated product pieces.

For purposes of sterilization, the cutting blades 60, the cutting roller 50, and any other contacting surfaces within the inventive vertical cutting apparatus 30 will preferably be maintained at a temperature of at least 145° F., more preferably at least 150° F., more preferably at least 155° F., more preferably at least 160° F., and most preferably at least 165° F. Additionally, horizontal ledges and other structures on which crumbs or other residue can rest and collect are preferably minimized or eliminated within the inventive vertical cutting apparatus 30.

Although one or more interior steam discharge tubes or nozzles 55 are shown in FIGS. 5 and 7 for continuously heating and sterilizing the blades 60, the roller 50, and other contacting surfaces within the inventive vertical cutting apparatus 30, it will be understood that the blades 60, roller 50 and other surfaces can alternatively be heated and sterilized (a) using one or more infrared heating elements, (b) by venting hot cooking vapor from the oven 4 into the inventive cutting apparatus 30, or (c) using other types of heating elements and techniques.

In the inventive cooking and cutting system 2 illustrated in FIGS. 1-3, the top opening 42 of the inventive cutting apparatus 30 and the product receiving nip 52 between the cutting head 48 and the cutting roller 50 are positioned beneath the outermost discharge end 28 of the oven belt 8 which projects from the oven outlet opening 16. Consequently, in accordance with the method of the present invention, as the hot cooked product travels over the outermost discharge end 28 of the oven belt 8, the hot cooked product becomes vertically oriented and is fed in this vertical orientation directly, while still at cooking temperature and preferably without contacting any other surface, into the receiving nip 52 of the blades 60 of the inventive cutting apparatus 30.

The cooked meat product received from the oven 4 by the inventive vertical cutting apparatus 30 can be (a) in the form of larger individual pieces, (b) in bonded sheet form as described above, or (c) in any other natural or processed form which is capable of being received and cut by the inventive vertical cutting apparatus 30. In addition, the product is preferably fully cooked so that the internal temperature of the cooked product is at least 150° F., more preferably at least 155° F., more preferably at least 160° F., more preferably at least 165° F. for beef and pork, and more preferably at least 175° F. or at least 180° F. for chicken or other poultry.

In one embodiment of the inventive method, the hot sliced, cubed, diced, or shred cut product will fall directly from the bottom discharge opening 44 of the inventive vertical cutting apparatus 30 into a pouch, bag, plastic container, or other final packaging for the product. The packaging will preferably be held by a box or other retainer on an in-line scale, or on or in proximity to some other sensing device, which will cause the filled package to be indexed to a vacuum sealer when a desired packaging weight, volume, or other amount of the product has been reached. After sealing, the packaged product will preferably be chilled or frozen.

The result of this process is an aseptically packaged product that has not been cross-contaminated by the cutting process and which retains sufficient temperature at the time of sealing to qualify as Alternative 1 or Alternative 2 under U.S.D.A. regulations. The inventive method therefore extends the shelf life of the product. In addition, the need for and the cost of operating a pre-chiller prior to cutting are eliminated and, by chilling the cut product in the packaging after sealing, evaporative losses are reduced and the product yield is thereby increased. Also, significant additional savings are realized by eliminating the need to inject the product with anti-microbials such as sodium lactate, which have heretofore been required in order to provide an acceptable shelf life.

As an additional step prior to sealing, the filled product package can optionally be indexed to a filling head for addition of a sauce, marinade, or other ingredient. The added sauce, marinade, or other ingredient will preferably be in a heated condition (i.e., preferably at least 150° F. and more preferably at least 160° F.). Vacuum sealing the product package after this additional step also helps to draw the added sauce, marinade, or other ingredient into the product.

In another embodiment of the inventive method, the hot sliced, cubed, diced, or shred cut product will fall from the bottom discharge opening 44 of the inventive vertical cutting apparatus 30 onto a transfer conveyor which will carry the product to a chilling or freezing apparatus for chilling or freezing prior to packaging. In this embodiment of the inventive method, cross-contamination in and prior to the product cutter is eliminated. In addition, the need for and cost of operating a pre-chiller prior to the cutting apparatus are also eliminated.

Also, in this embodiment of the inventive method, the risk of cross-contamination can be further reduced by dropping the sliced, cubed, shred cut or diced product onto a Unitherm transfer conveyor or other transfer conveyor having a built-in belt sanitizer and then chilling or freezing the product in a Unitherm spiral freezer or other spiral freezer wherein a steam sterilization step is performed frequently (preferably every day) after clean-in-place washing.

The built-in belt sanitizer for the transfer conveyor can be a chemical sanitizer system but will more preferably be a steam or hot water system which heats the conveyor, or at least the contact points thereof, to a temperature of at least 140° F., more preferably at least 150° F., more preferably at least 160° F., more preferably at least 170° F., more preferably at least 175° F., more preferably at least 180° F., and more preferably at least 185° F. The use of steam or hot water under pressure also assists in removing surface debris.

Thus, the present invention is well adapted to carry out the objectives and attain the ends and advantages mentioned above as well as those inherent therein. While presently preferred embodiments and steps have been described for purposes of this disclosure, the invention is not limited in its application to the details of the preferred embodiments and steps. Numerous changes and modifications will be apparent to those of ordinary skill in the art. Such changes and modifications are encompassed within this invention as defined by the claims. In addition, unless expressly stated, the phraseology and terminology employed herein are for purposes of description and not limitation.

What is claimed is:

1. An apparatus for vertically cutting a food product comprising:
a housing having an upper product inlet opening;
a cutting head driveably installed in the housing for driven rotation of the cutting head in a cutting direction;
a roller rotatably installed in the housing adjacent and parallel to the cutting head;
an upwardly facing product receiving nip formed between the cutting head and the roller; and
a vertical cutting path defined in the apparatus which travels downwardly into the upwardly facing product receiving nip and then continues downwardly between the cutting head and the roller.

2. The apparatus of claim 1 further comprising a drive motor which drives the cutting head in the cutting direction.

3. The apparatus of claim 1 wherein the cutting head comprises a series of radially extending circular cutting blades.

4. The apparatus of claim 3 wherein:
the radially extending circular cutting blades have outer circular cutting edges and
the roller comprises a series of circular exterior grooves corresponding to the series of circular cutting blades for receiving the outer circular cutting edges of the circular cutting blades as the outer circular cutting edges meet the roller at the upwardly facing product receiving nip.

5. An assembly for cutting a sterile cooked meat product comprising;
a heating apparatus having a product outlet and
a vertical cutting apparatus installed on the heating apparatus beneath the product outlet of the heating apparatus, wherein the vertical cutting apparatus comprises:
a housing having an upper product inlet opening;
a cutting head driveably installed in the housing for driven rotation of the cutting head in a cutting direction;
a roller rotatably installed in the housing adjacent and parallel to the cutting head;
an upwardly facing product receiving nip formed between the cutting head and the roller; and
a vertical cutting path defined in the vertical cutting apparatus which travels downwardly into the upwardly facing product receiving nip and then continues downwardly between the cutting head and the roller.

6. The assembly of claim 5 wherein the heating apparatus is an oven.

7. The assembly of claim 6 wherein:
the oven has a product conveyor for carrying product through the oven;
the product conveyor has an outlet end which projects from the product outlet of the oven; and
the outlet end of the of the product conveyor is positioned above the upper product inlet opening of the vertical cutting apparatus and above the upwardly facing product receiving nip formed between the cutting head and the roller.

8. The assembly of claim 5 wherein the heating apparatus is a spiral oven.

9. The assembly of claim 8 wherein:
the spiral oven has a conveyor therein for carrying product upwardly through the oven in a spiral pattern;
the conveyor has an outlet end which projects from the product outlet of the spiral oven; and
the outlet end of the of the conveyor is positioned above the upper product inlet opening of the vertical cutting apparatus and above the upwardly facing product receiving nip formed between the cutting head and the roller.

10. The assembly of claim 9 further comprising:
an exterior hood positioned over the product outlet of the spiral oven and
a shield structure which extends upwardly from the vertical cutting apparatus to substantially enclose a bottom opening of the exterior hood.

11. The assembly of claim of claim 8 wherein the vertical cutting apparatus is movably installed on the spiral oven for movement from an operating position beneath the product outlet of the spiral oven to a non-operating position removed from the product outlet of the spiral oven.

12. A method of producing a pre-cooked meat product comprising the steps of:
delivering a meat product through a heating apparatus to a product outlet of the heating apparatus and
cutting the meat product into separate smaller pieces by delivering the meat product vertically downward from the product outlet of the heating apparatus through a vertical cutting apparatus positioned below the product outlet of the heating apparatus.

13. The method of claim 12 wherein, in step (b), the meat product is received from the product outlet of the heating apparatus through a top opening of the vertical cutting apparatus and travels vertically downward through the vertical cutting apparatus to a bottom discharge opening of the vertical cutting apparatus.

14. The method of claim 12 wherein
the heating apparatus has an product conveyor which conveys the meat product through the heating apparatus;
the product conveyor has an outlet end which projects from the product outlet of the heating apparatus; and
the outlet end of the of the product conveyor is positioned above a top opening of the vertical cutting apparatus.

15. The method of claim 12 wherein the meat product delivered through the heating apparatus in step (a) is a cooked meat product and the heating apparatus is a surface pasteurizer which kills pathogens on an outer surface of the cooked meat product.

16. The method of claim 12 wherein the heating apparatus is an oven in which the meat product is cooked in step (a).

17. The method of claim 16 wherein the heating apparatus is a spiral oven.

18. The method of claim 16 wherein the separate smaller pieces of the cooked meat product produced in step (b) are discharged directly from the vertical cutting apparatus into product packages.

19. The method of claim 18 wherein the product packages into which the separate smaller pieces of the cooked meat product are discharged are next vacuum sealed without being further processed prior to sealing.

20. The method of claim 18 wherein, after the separate smaller pieces of the cooked meat product are discharged into the product packages, a sauce or marinade is next added to the product packages and the product packages are then vacuum sealed without being further processed prior to sealing.
